(19) United States
(12) Patent Application Publication
(10) Pub. No.: US 2013/0052327 A1
(43) Pub. Date: Feb. 28, 2013

(54) COMPOSITIONS AND METHODS FOR PREPARING COOKED RICE

(71) Applicant: Philip Sinz, Seattle, WA (US)

(72) Inventor: Philip Sinz, Seattle, WA (US)

(21) Appl. No.: 13/601,189

(22) Filed: Aug. 31, 2012

Related U.S. Application Data
(60) Provisional application No. 61/529,713, filed on Aug. 31, 2011.

(51) Int. Cl. A23L 1/182

(52) U.S. Cl. 426/626

(57) ABSTRACT

The disclosure herein concerns the preparation of cooked rice using acidic, salt-containing vinegar-based compositions that lack sucrose and/or fructose containing sweetener additives. The salt used include at least one of a safely consumable sodium based salt and a safely consumable potassium based salt, the content of each or both being configured to enhance and adjust retrogradation resistance of the cooked rice depending on whether the cooked rice is to be stored refrigerated or frozen, and if frozen, the temperature range the cooked rice it is to be thawed. The acidic, vinegar-based non-sucrose/non-fructose compositions include vinegar solutions having different levels of salt content configured to accommodate different storage and processing conditions of the cooked rice so that the cooked rice presents a palatably pleasing experience to the consumer.

### PRIORITY CLAIM

This application claims priority to, and incorporates by reference, U.S. Provisional Appl. No. 61/529,713 filed Aug. 31, 2011.

### BACKGROUND OF THE INVENTION

Carbohydrate-based foods, such as cooked rice, are often susceptible to rapid spoiling at ambient temperatures. When frozen, these carbohydrate based foods can be susceptible to degrading processes during refrigerator- and/or freezer-based cold storage that is unwelcomingly evident to the user's palate when subsequently thawed and processed for consumption. Retrogradation, as regards cooked rice, is defined as that level of substantial degradation detectable by the human palate (taste and/or texture) that commonly occurs when cooked rice is stored under refrigerated conditions within a 33-50 degree F. range, or alternatively, when the cooked rice is stored in the freezer within a 0-32 degree F. range. The user's palate detects a stale taste or negatively reacts to the food stuff's altered texture that developed during frozen storage. For example, sushi, or cooked seasoned rice having significant amounts of sugar-containing vinegar, while frozen or when stored at refrigerated temperatures, can suffer retrogradation processes that leads to spoilage, staling and/or having altered textures and tastes that are objectionable to the human palate or otherwise discourage the consumption of the cooked rice. Retrogradation of refrigerator- and/or freezer-based cooked rice is noticeable by the consumer when the rice cooked rice develops a dried, rough surface, often split-open, and presenting a spotted, bumpy or crumbly texture that is markedly repugnant to the consumers palate as compared to freshly cooked rice that is soft, pliable, sticky, and smooth surfaced that goes down easily. Retrogradation is also noticed by those consumers who use chop sticks and find that the degraded cooked rice can't be grasped and held by the chopsticks because the dried, split-open and rough-surfaced rice is not amenable for pinch holding by the chopstick users, whereas the freshly cooked rice can be pinch-held because it is pliable, soft, sticky and easily grasped by the chopsticks.

Furthermore, it is known that the rate of retrogradation with respect to temperature is not a constant value, or undergoes a linear rate. Retrogradation rates can vary widely at different temperatures, as an example, the rate of retrogradation at 50 F is less than the rate of retrogradation at 30 F Retrogradation is further differentially affected by the presence of certain ingredients, particularly with high levels of sucrose and/or fructose as described above at certain temperature ranges. Freezer condition retrogradation is particularly evident for cooked rice that is processed with conventional vinegar formulations that have sucrose and/or fructose based sweeteners at levels added at the ratio of about 30-50 grams sucrose and/or fructose compositions per 453 grams of dried or uncooked rice. Retrogradation often occurs for cooked rice that is stored in refrigerated environments for substantial periods.

### SUMMARY OF THE INVENTION

An embodiment includes cooked rice amenable for refrigerated or frozen storage comprising hydrated rice derived from uncooked rice; an acidic compound; a sweetening compound including 0-29 grams of at least one of sucrose and fructose per 453 grams of uncooked rice; and a salt compound.

### BRIEF DESCRIPTION OF THE DRAWING

Examples of particular embodiments of the present invention are described in detail below with reference to the following drawings:

FIG. 1 schematically depicts a method to prepare cooked rice using a salt-based vinegar non-sucrose/non-fructose containing solution formulated to enhance retro gradation resistance for either refrigerator storage, freezer storage, and room temperature or refrigerator temperature thawing; and

FIG. 2 schematically depicts a method to prepare cooked rice using a salt-based vinegar non-sucrose/non-fructose containing solution formulated to enhance retrogradation and further including and at least one of a bread, meat, and flavoring additive for either refrigerator storage, freezer storage, and room temperature or refrigerator temperature thawing.

### DETAILED DESCRIPTION OF THE PARTICULAR EMBODIMENTS

Disclosure herein provides compositions and method solutions to control and limit deleterious retrogradation processes to cooked food stuffs, especially cooked rice, and allow for flexibility of storage and processing conditions,

Embodiments of the invention concern the preparation and/or storage of cooked rice under refrigerated and/or freezer conditions in which the uncooked or dried rice is hydrated using compositions configured to substantially reduce or eliminate retrogradation of the cooked rice when stored in the refrigerator, freezer, or transitioning between freezer and/or refrigerator storage. The compositions include at least one of water, water and a safely consumable salt, acidified water and a safely consumable salt, water with a safely consumable salt and a low molecular weight carbohydrate sweetener and/or non-carbohydrate sweetener, acidified water with a safely consumable salt and a low-molecular-weight carbohydrate sweetener and/or non-carbohydrate sweetener, water with a safely consumable salt and a high-molecular-weight carbohydrate sweetener and/or non-carbohydrate sweetener, and acidified water with a safely consumable salt and a high molecular weight carbohydrate sweetener and/or non-carbohydrate sweetener. The acidified water may include vinegar-based aqueous solutions (acetic acid) and/or safely consumable quantities of at least one of citric, lactic, hydrochloric, and phosphoric acid solutions. The safely consumable salt includes at least one of a sodium salt and a potassium salt. The carbohydrate based sweetener includes low molecular weight or monomer substances such as sucrose, fructose, and other carbohydrate monomers. The carbohydrate based sweetener also may include higher molecular weight or polymer substances such as polysaccharides.

Among the acidic, salt-containing vinegar-based compositions are those configured to reduce or eliminate retrogradation attributable to the presence of carbohydrate based sweeteners and to adjust the salt levels to enhance retrogradation resistance to allow longer storage times at both refrigerator and freezer temperatures. In general the formulations of the acidic, salt-containing vinegar-based compositions substantially slow down the rate of retrogradation within the temperature range of approximately 10 F-50 F. In particular embodiments, the acidic, salt containing formulations are directed to optimizing the minimizing of retrogradation at freezer-based temperatures (≦10 F-32 F), refrigerator-based temperatures (33 F-50 F), and/or cold storage under mixed conditions, for example in which the cooked rice is stored sequentially at freezer temperatures followed by refrigerated temperatures, or alternatively, refrigerated temperatures followed by freezer temperatures. Disclosure below provides solutions for the retrogradation of refrigerated rice generally stored between 33 F to 50 F and frozen rice generally stored between 10 F and 32 F by testing the impact of sugar levels on the retrogradation of refrigerated and frozen cooked rice at prolonged exposure times and with regard to ranges of safely consumable sodium and/or potassium salts.

Compositions for storing cooked rice at freezer-based temperatures defined to occupy the temperature range of approximately ≦10 F-32 F includes an acidic vinegar having at least one of a safely human consumable sodium salt and/or a safely consumable potassium salt, and at least one of sucrose, fructose, or other polysaccharide at levels substantially greater than 50 grams sucrose and/or fructose and/or other mono or polysaccharide composition per 453 grams of dried or uncooked rice. The sodium salt is a safely human consumable salt such as sodium chloride. The potassium salt includes potassium chloride and/or potassium lactate. Other particular embodiments provide for compositions for storing acidified cooked rice (pH≦4.6) at freezer-based temperatures defined to occupy the temperature range of approximately ≦10 F-32 F includes an acidic vinegar, and for human palatability reasons, can include a “saltiness” imparting substance, such as a safely human consumable sodium salt, a safely consumable potassium salt, a “salt substitute” (e.g. amino acids or yeast extracts). The sodium salt is a safely human consumable salt such as sodium chloride. The potassium salt includes potassium chloride and/or potassium lactate. Again, for human palatability reasons, a “sweetness” imparting substance can be added; including but not limited to sucrose, fructose, or other polysaccharide at levels substantially less than 30 grams sucrose and/or fructose and/or other mono or polysaccharide composition per 453 grams of dried or uncooked rice. In addition to the solutions mentioned above, retrogradation resistance can be further enhanced with addition of: higher concentrations of water (above the 1.4× used in the current art), hydrocolloids (xanthan gum, gelatin and other collagen derivates, carrageenan, etc.), enzymes, fats, emulsifiers and surfactants (e.g. soy lecithin).

Compositions for storing cooked rice at refrigerator-based temperatures defined to occupy the temperature range of approximately 33 F-50 F includes an acidic vinegar having at least one of a safely human-consumable sodium salt and a safely consumable potassium salt, and no added carbohydrate based sweeteners, including sucrose-based and/or fructose-based, and other non-sucrose/non-fructose based carbohydrate sweeteners, including mono and polysaccharides. That is, the composition for storing cooked rice is primarily acidic vinegar compositions having at least one of a safely consumable sodium salt and a safely consumable potassium salt. The sodium salt includes sodium chloride and the potassium salt includes potassium chloride and/or potassium lactate.

Compositions for storing cooked rice at freezer-based temperatures of approximately ≦10 F-32 F followed by refrigerated temperatures of approximately 33 F-50 F, or conversely, refrigerated storage followed by freezer storage, includes an acidic vinegar having at least one of a safely human consumable sodium salt and a safely consumable potassium salt, and at least one of sucrose, fructose, or other polysaccharide at levels substantially less than 30 grams sucrose and/or fructose and/or other mono or polysaccharide composition per 453 grams of dried or uncooked rice. The sodium salt is a safely human consumable salt such as sodium chloride. The potassium salt includes potassium chloride and/or potassium lactate. In alternate particular embodiments for freezer to refrigerator or refrigerator to freezer storage spanning the approximate temperature range of ≦10 F-50 F, the sucrose, or fructose, other mono or polysaccharide sweeteners, or any combination thereof, can be present in the acidic vinegar salt-containing compositions at 1-25 grams of carbohydrate based sweeteners per 453 grams of dried or uncooked rice.

Sugars and sugar alcohols (sucrose, glucose, fructose, high fructose corn syrup, sugar alcohols) may have minimal retrogradation in refrigerator temperature ranges spanning 33 F to 50 F, but in temperatures of 32 F and lower (i.e., freezer-based temperatures), these sugar and sugar alcohols exhibit increased retrogradation that hampers the storage of cooked rice products for substantial periods.

Retrogradation can be minimized or eliminated depending on the temperature range of the cold storage and upon the variety and type of low molecular weight substances contained within the cooked rice. For example, seasoned vinegar having salt compounds and other low molecular weight items to lower the glass transition phase. Salt lowers the freezing point of liquids below 32 F, and exposes cooked rice having these liquids to a slower freezing process, and so shifts the retrogradation range to lower temperatures. For example, if rice retrogrades from 10 F to 50 F, adding enough salt can shift die retrogradation range to a lower temperature range by five degrees (i.e., 5 F to 45 F).

An embodiment includes acidic, salt-based vinegar formulations that are designed to reduce the rate of retrogradation by substantially reducing or eliminating sucrose-based sweeteners, fructose-based sweeteners (i.e., fructose-enhanced corn syrup), or other carbohydrate-based sweeteners for the storage of cooked rice at refrigerator temperatures. The salts used to enhance retrogradation resistance include at least one of a safely consumable sodium-based salt and a safely consumable potassium-based salt, the content of each or both being configured to enhance and adjust retrogradation resistance of the cooked rice depending on whether die cooked rice is to be stored refrigerated or frozen, and if frozen, the temperature range the cooked rice it is to be thawed. The acidic, vinegar-based non-sucrose/non-fructose compositions include vinegar solutions having different levels of salt content configured to accommodate different storage and processing conditions of the cooked rice so that the cooked rice presents a palatably pleasing experience to the consuming public.

Embodiments of the invention include the addition of vinegar-based components having low molecular weight solutes, such as salt, to effectively shift the retrogradation curve and thus lessen the impact of retrogradation in specific temperature ranges desired for storing cooked rice and its seasoned derivatives. The various embodiments provide for a salt containing vinegar solution having at least one of white or rice-vinegar and no carbohydrate based added sweeteners, particularly no sucrose and/or no fructose based sweeteners. A vinegar-based, salt-containing solution has been found to be optimal for freezer storage in the temperature range of less than 0 F to 32 F. Other various embodiments described below include examples of vinegar-based non-sucrose, non-fructose solutions having a relatively high salt content that is amenable to storing cooked rice under refrigerator temperature conditions, particularly between approximately 33 F-50 F. Another vinegar solution having a medium salt content is amenable to storing cooked rice under freezer temperature conditions and to allow subsequent thawing at ambient or room temperatures. Yet another vinegar solution having a relatively low salt content is amenable to freezer temperature storage and to allow subsequent thawing under refrigerator temperature conditions. The relatively high, medium, and low salt content solutions may be devoid of sucrose and fructose additives that are optimally configured to diminish or eliminate retrogradation attributable to the presence of these carbohydrate based sweeteners so that cooked rice can be stored for extended periods yet remain palatably pleasing to the consumer. In other embodiments non-sucrose sweeteners, non-fructose sweeteners, sucrose sweeteners, and fructose based sweeteners may be added at content levels that confer pleasing tastes to the consumer yet do not exhibit substantial retrogradation to the cooked rice when placed in refrigerator or freezer storage, or impart retrogradation resistance to the frozen cooked rice when subsequently thawed at refrigerator temperatures or higher room temperatures.

The salt content within a given vinegar solution can shift the retrogradation curve to lessen or eliminate the Impact of retrogradation in specific temperature ranges that the cooked rice will be exposed to during storage. Accordingly, the vinegar-based compositions and methods of preparing cooked rice can vary depending on whether the cooked rice is intended for refrigerated storage between 33-50 F or freezer storage between 0-32 F. For cooked rice products stored in freezer conditions, the vinegar-based, salt-containing compositions can also vary depending if the frozen cooked rice products are to be slowly thawed under refrigerated temperatures or thawed more rapidly under higher ambient room temperatures.

The formulations of the vinegar-based compositions that eliminate or lessen retrogradation under various storage and thawing conditions described above are based on the substantial reduction-to-elimination of sucrose and/or fructose enhanced sweeteners and by adjusting the salt content within the acetic vinegar solutions. Shifting of the retrogradation curves away from the intended temperature storage range is governed by the salt level contained within the vinegar based solution. This retrogradation curve shifting confers the retrogradation resistance to the cooked rice under various storage temperatures and thawing exposures. The decrease-to-elimination of sucrose/fructose additives proportionately lessens the contribution of sugar related retrogradation.

Retrogradation resistance is understood to mean the minimization-to-elimination of degradation noticeable by the human palate in terms of taste and food texture that commonly occurs in the retrogradation danger zone. The retrogradation danger zone for cooked rice is defined to occupy approximately 0 F to 50 F, particularly when utilizing compositions other than those described for the preferred and alternate embodiments in the disclosure above and further discussed in the disclosure below. Retrogradation rates are generally larger within the 10 F-50 F temperature range, particularly for vinegar-based solutions having high sugar content.

The compositions may include carbohydrates other than sucrose or fructose enhanced corn syrup, for example, soybean polysaccharides, trehalose, and Stevia rebaudiana. The compositions may include sodium chloride (NaCl), potassium chloride (KCl), potassium lactate (K-lactate) or combinations of NaCl and KCL and K-lactate, The formulations utilizing NaCl are at greater levels than those found in conventional sucrose containing vinegar-based formulations. The use of NaCl, KCL K-lactate, or any combinations of these salts in the absence of added sucrose or fructose based sweeteners imparts significant retrogradation resistance to the cooked rice when stored at refrigerated or freezer temperatures and when freezer-stored cooked rice is thawed slowly under refrigerator temperature conditions or relatively faster under ambient, room temperature conditions.

In other embodiments the cooked rice and the methods to produce the cooked rice amenable for refrigerated or freezer storage and either slow thawing under refrigerator conditions and a more rapid thaw at room temperature conditions with temperatures greater than refrigerator conditions further includes adding at least one of a bread, a meat (i.e., a protein compound), at least one vegetable, and a flavoring agent. The meat may include fish. The bread, meat, vegetables and flavoring agents benefit from the retrogradation resistance conferred by the vinegar-based salt containing solutions described above and below.

Embodiments may be more fully understood with regards to the drawing figures.

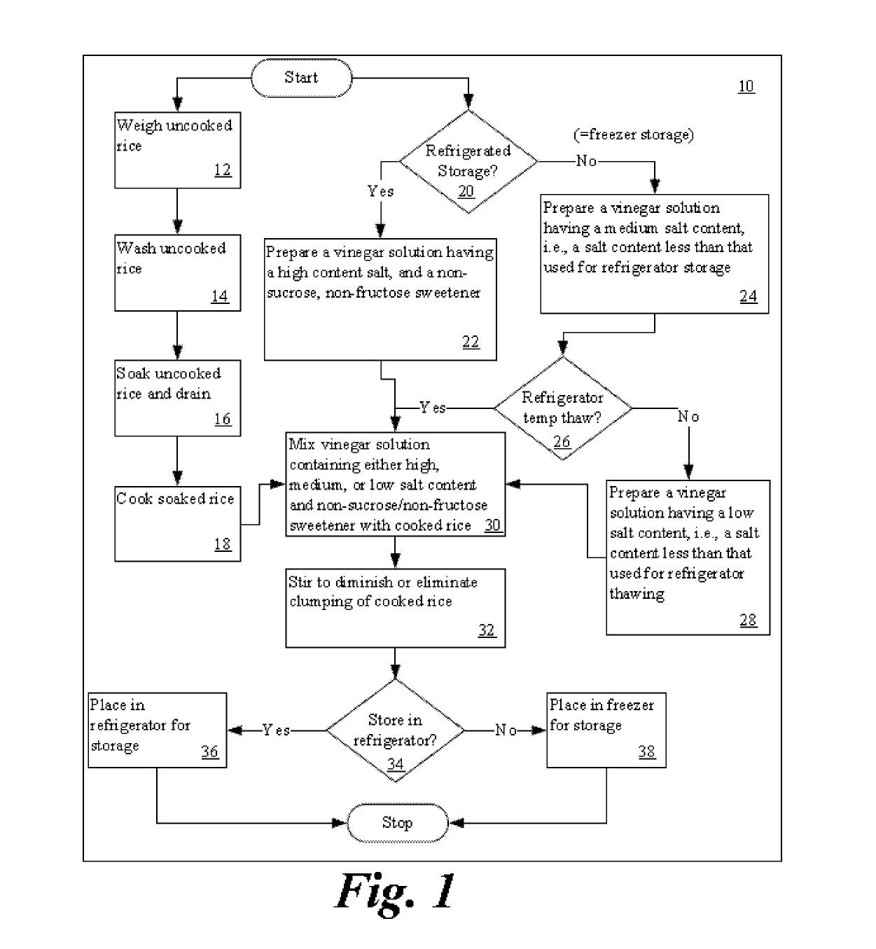

FIG. 1 depicts a method 10 to prepare cooked rice using a salt-based vinegar non-sucrose/non-fructose containing solution formulated to enhance retrogradation resistance for either refrigerator storage at approximately 33 F-50 F, freezer storage at approximately 0 F-32 F, and refrigerator temperature thawing or at ambient room temperature thawing at temperatures greater than refrigerator thawing. Method 10 commences with two parallel or consecutive processes: preparing cooked rice and preparing an acidic, vinegar-based non-sucrose/non-fructose solution configured to provide adjustable retrogradation resistance to the cooked rice through variation of the salt content to impart enhanced refrigerator and/or freezer storage. The vinegar solutions may include optionally added non-sucrose and non-fructose sweeteners, the addition of which may depend on whether the cooked rice is destined for refrigerator or freezer storage, or if frozen, whether thawing is to be undertaken in refrigerator temperatures or at higher ambient room temperatures. Accordingly, the acidic, vinegar-based non-sucrose/non-fructose solutions are prepared having salt content at relative high levels, relatively medium levels, or relatively low salt content levels. Examples of what constitutes relatively high, medium, and low salt content levels are discussed below.

Referring still to FIG. 1, the preparing of cooked rice commences with weighing of the uncooked or dried rice at process block 12, then washing the uncooked rice at process block 14, soaking and draining at process block 16, then cooking at process block 18. Preparation of the acidic, vinegar-based non-sucrose/non-fructose salt-containing solution begins with the query if the cooked rice is destined for refrigerated storage at decision diamond 20. If affirmative, then the vinegar solution is prepared to contain a relatively high level of salt, the salt having at least one of a sodium-based salt and a potassium-based salt, and a sweetener that may be added that is not comprised of sucrose or fructose, as for example, no fructose enhanced corn syrup. The addition of the non-sucrose/non-fructose sweetener additive is optional in that it is added at levels to accommodate the taste preferences of the consuming public, and not necessarily to adjust retrogradation resistance so that the cooked rice is not exposed to food texture-altering retrogradation.

Retrogradation resistance, and its adjustability, is determined by the salt content of the vinegar solution and the absence of sucrose and/or fructose additives. Still referring to FIG. 1, if die cooked rice is not destined for storage under refrigerated conditions, then the cooked rice is destined for freezer storage. In this event, the salt content of the vinegar solution in process block 24 is adjusted to be less than the higher salt content used for refrigerator storage at process block 22, This lower level of salt content in process block 24 is deemed to be a medium salt content vinegar solution. However, If the answer is negative for whether the freezer-stored cooked rice is intended for slower refrigerator temperature thawing as indicated in decision diamond 26, the salt content in the vinegar solution is lowered yet again to have a low salt content in process block 28. That low salt content vinegar solution may also contain the non-sucrose and non-fructose sweetener added to the cooked rice at process block 30. Alternatively, if the cooked rice is indicated for refrigerator storage, then the higher salt content vinegar solution is mixed with the cooked rice at process block 30. If, on the other hand, the freezer-stored cooked rice is Intended to be more rapidly thawed at ambient or room temperature in which the ambient temperature is greater than the refrigerator temperature, the vinegar solution is prepared to have even lower salt content than if the freezer-stored cooked were to undergo thawing at refrigerator temperatures. Upon addition of the non-sucrose/non-fructose high salt content vinegar solution, the medium salt content vinegar solution, or the low salt content vinegar solution, the cooked rice is then de-clumped by stirring at process block 32. Thereafter, at decision diamond 34, if the answer is affirmative to the query “Store in refrigerator?”, method 10 concludes with the cooked rice being placed in the refrigerator for storage at process block 36. If negative, then method 10 concludes with the cooked rice being placed in the freezer for storage at process block 38.

In expanded detail the cooking portion of FIGURE 1 includes weighing out 453 grams of uncooked rice, either medium or short gain at process block 12. At process block 14, the uncooked rice is washed gently to avoid breaking rice grains, and is continued until the water runs clear, indicating that excess starch has been washed away from the rice grains. At process block 16, the uncooked rice is soaked for approximately two hours In enough water to completely submerge the rice grains, Submersion ensures an even hydration of the rice can occur during cooking, leading to a more uniform texture and a softer rice core. The soak times can be varied. The soaked rice is then drained. At process block 18, new water is added such that the total water weight is approximately 40% greater (1.4×) than the total dried or uncooked rice weight. Restated equivalently, the total weight of the rice plus the water weight (both soaked into the rice grains and that water added to the pot) is approximately 2.4× (or 140% greater) than the dried or uncooked rice weight. Referring still to process block 18, the heat is applied to the rice cooker vessel holding the rice and water and cooking proceeds in the rice cooker for approximately 40 minutes total. The rice cooker cooks for the first approximate 20 minutes, then the heat is removed. During the last 20 minutes the rice rests and absorbs excess moisture in the pot.

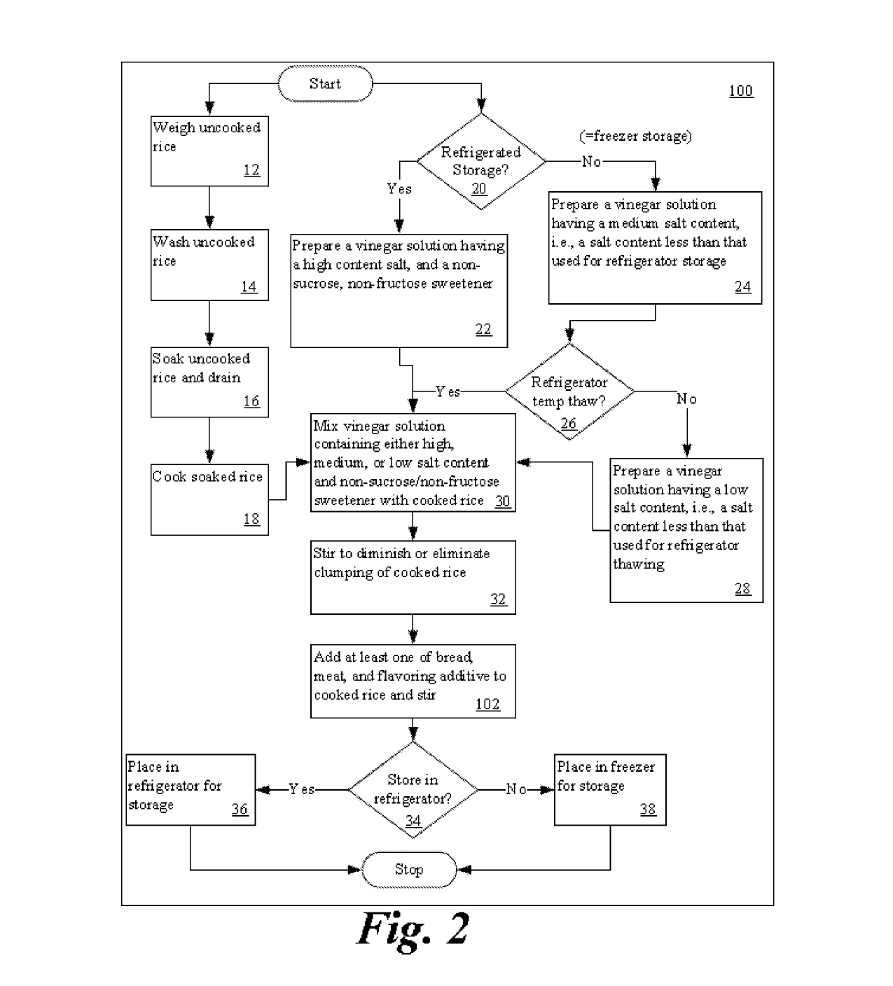

FIG. 2 schematically depicts a method 100 to prepare cooked rice using a salt-based vinegar non-sucrose/non-fructose containing solution formulated to enhance retrogradation and further including and at least one of a bread, meat, and flavoring additive for either refrigerator storage, freezer storage, and room temperature or refrigerator temperature thawing. Method 100 is substantially the same as method 10, but with process block 102 added in which at least one of a bread, a meat, at least one vegetable, and a flavoring additive is added to the stirred, cooked rice, and then roiled together and mixed. Adding of meats, breads, and vegetables occurs by rolling these components into the cooked rice. The meats include at least one of fish, beef, and fowl. Other components that may be added include hydrocolloids and enzymes. Method 100 is then completed when the bread, and/or meat, and/or flavoring additive containing cooked and de-clumped rice is placed for refrigerator storage at process block 36 or freezer storage at process block 38. Freezing temperatures can vary; however, the colder the freezer, the better the chances to imbue a palatably pleasing texture to the cooked rice, as colder freezers have improved, or faster heat transfer rates hasten, the freezing process and thus minimize the time the cooked rice is exposed In the retrogradation danger zone.

Examples of what can be construed to be high, medium, and low salt level contents for the vinegar non-sucrose/non-fructose solutions are described in process blocks 22, 24, and 28 for FIGS. 1 and 2 above. The high, medium, and low salt level contents are generally added at a ratio of approximately spanning the range of 10 to 20 grams of salt per that quantity of cooked or hydrated rice derivable from 453 grams of uncooked or dried rice. That is, for example, 20 grams of salt per 453 grams of uncooked rice can be deemed a high salt content for process block 22, 15 grams of salt per 453 grams of uncooked or dried rice can be deemed a medium salt content for process block 24, and 10 grams of salt per 453 grams of uncooked or dried rice deemed a low salt content for process block 28. The salt may include any combination of a sodium-based salt and a potassium based salt. The sodium-based salt can include sodium chloride and the potassium based salt at least one of potassium chloride and potassium lactate. For optimization at refrigerator storage between 33 F-50 F, the salt-containing vinegar solutions includes relatively high salt content for NaCl, KCl, K-lactate, either separately or any combination thereof to shift retrogradation curves away from the intended storage temperature along with elimination of sugar carbohydrate additives to eliminate the sugar's additives contribution to retrogradation. However, depending on the salt content and its resulting shifting of the retrogradation curve away from the 33 F-50 F temperature range, non-sucrose/non-fructose sweeteners and sucrose and fructose based sweeteners may be added at levels that do not substantially decrease the retrogradation resistance conferred by the salt content or substantially increase sugar-based retrogradation that would otherwise be noticeable to the human palate. The blend of sodium chloride and potassium chloride may be a 50/50 blend, say 10 grams of NaCl and 10 grams of KCl in the case of a high salt content, and say 5 grams of NaCl and 5 grams KCl for the low salt content. The 50/50 blend for the high salt content can also be 0 grams NaCl and 10 grams KCl and 10 grams K-lactate. The blends may also be 50/25/25 for the high salt content in which 10 grams of NaCl and blended with 5 grams KCl and 5 grams K-lactate. Other blends can be 10% NaCl/90% KCl or K-lactate, 90% NaCl/10% K-lactate or KCl, 20% NaCl/60% KCl/20% K-lactate or other combinations to effect either a high salt content of 20 grams, medium salt content of 15 grams, and low salt content of 10 grams. As pertains to refrigerated storage only (i.e. the product never gets below 32 F), the molar concentration equivalent for low molecular weight carbohydrate additives can exceed 50 grams per 453 grams of dried (uncooked) rice to compensate for the salt-caused leftward shifting of the retrogradation curve more deeply into the colder temperatures as retrogradation attributable to carbohydrate sweeteners in refrigerated conditions is relatively small as compared to freezer temperatures.

The vinegar non-sucrose/non-fructose solutions having the respective relatively high, medium, and low salt content described in process blocks 22, 24, and 28 is mixed into the cooked rice per process block 36. Similarly, salt-containing vinegar solutions having carbohydrate-based sweeteners (non-sucrose and sucrose based; non-fructose and fructose based) at levels that doesn't lessen the salt-enhanced retrogradation resistance made in process blocks 22, 24, and 28 may be similarly mixed into the cooked rice per process block 36. The cooked rice is dumped from the pot into a bowl having a large surface area to volume ratio. The salt-containing vinegar solutions are poured evenly over the cooked rice per process block 30 and gently stirred with a paddle per process block 32 to break down rice clumps such that the individual cooked rice grains are not sticking to each other so that refrigerator or freezer-stored cooked rice possesses a product texture pleasing to the user's palate.

The range of what defines the minimum to function as a low salt content can be increased above 10 grams or decreased below 10 grams. Similarly, the range that defines the maximum to function as a high salt content may be adjusted to be less than 20 grams or greater than 20 grams. For example, in other embodiments the salt range may span between approximately 15 grams to denote a low salt content to approximately 25 grams to denote a high salt content per 453 grams of uncooked (dried) rice. Medium can be defined as that salt content near the middle of the low and high limits.

The non-sucrose/non-fructose sweeteners that may be optionally added to the low salt, medium salt, and high salt containing vinegar solutions pertaining to process blocks 22, 24, and 28. The non-sucrose/non-fructose sweeteners may include at least one of soybean polysaccharides, trehalose, and Stevia rebaudiana. Sweet leaf or Stevia rebaudiana may be added at a ratio of 0.35 grams per that quantity of cooked or hydrated rice derivable from 453 grams of uncooked (dried) rice. The quantity dosage and number of non-sucrose/non-fructose sweeteners that may be used is determined by product acceptance as governed by the consuming public's collective palate. Similarly, the quantity of type of vinegar used in the high, medium, or low salt content solutions described in process blocks 22, 24, and 28 is also determined by the customer's palate. White or rice vinegar may be used at, for example, 90 grams of white or distilled vinegar per that quantity of cooked or hydrated rice derivable from 453 grams of uncooked rice.

In an embodiment, the vinegar solution consists of an acid compound, a sweetener compound, and a salt compound. In this embodiment, it is preferred, but not required, to use 90 grams of white distilled vinegar, 0.35 grams of stevia (Stevia rebaudiana), and 20 grams of a salt blend consisting of potassium chloride and sodium chloride.

While the preferred embodiment of the invention has been illustrated and described, as noted above, many changes can be made without departing from the spirit and scope of the invention. For example, in alternate embodiments the retrogradation resistant formulations may be blended to accommodate the highest temperature the cooked rice is expected to encounter while being transported under refrigerated or freezer conditions. In yet other embodiments, certain vinegar salt-containing compositions found to confer retrogradation resistance may allow the re-introduction of sucrose and/or fructose enhance sweeteners at lower levels to not lessen retrogradation resistance and so accommodate consumer taste preferences while maintaining consumer-acceptable cooked rice textures. For example, the salt-containing seasoning vinegar based solutions may accommodate sucrose and/or fructose levels to be present in the 0.5-20 gram range per 453 grams of dried rice. Sucrose and/or fructose enhanced com syrup at the 0.5-25 gram level in a vinegar-based salt solution maintains retrogradation resistance and so confers the ability to store cooked, seasoned rice at refrigerator and freezer temperatures to achieve a consumer pleasing palatable and chopstick-handling experience. In yet another embodiment, the sucrose sweetener and the fructose sweetener is added at less than 30 grams of sucrose, or less than 30 grams fructose, or less than the combined weight of 30 grams of sucrose and fructose per that quantity of hydrated rice derivable from 453 grams of uncooked rice.

Accordingly, the scope of the invention is not limited by the disclosure of the preferred and alternate embodiments. Instead, the invention should be determined entirely by reference to the claims that follow.

The embodiments of the invention in which an exclusive property or privilege is claimed are defined as follows:

1. A cooked rice amenable for refrigerated or frozen storage comprising:
hydrated rice derived from uncooked rice;
an acidic compound;
a sweetening compound including 0-29 grams of at least one of sucrose and fructose per 453 grams of uncooked rice; and
a salt compound.

2. The cooked rice of claim 1, wherein the sweetening compound includes at least one of a non-sucrose sweetener and a non-fructose sweetener.

3. The cooked rice of claim 1, wherein the salt compound includes 10 to 20 grams of sodium chloride per 453 grams of uncooked rice.

4. The cooked rice of claim 1, wherein the acidic compound includes at least one of white distilled vinegar and rice vinegar.

5. The cooked rice of claim 1, wherein the salt compound includes at least one of potassium chloride and potassium lactate.

6. The cooked rice of claim 5, wherein the at least one of potassium chloride and potassium lactate includes 10 to 20 grams of the at least one of potassium chloride and potassium lactate per 453 grams of uncooked rice.

7. The cooked rice of claim 1, wherein the salt compound includes 10 grams of sodium salt and 10 grams of potassium salt per 453 grams of uncooked rice.

8. The cooked rice of claim 7, wherein the 10 grams of sodium salt includes sodium chloride and the 10 grams of potassium salt includes at least one of a potassium chloride and potassium lactate.

9. The cooked rice of claim 1, wherein the quantity of the salt compound is larger for refrigerator storage and smaller for freezer storage.

10. The cooked rice of claim 1, wherein the quantity of the salt compound is larger for thawing under refrigerator temperatures and smaller for thawing under room temperature conditions.

11. The cooked rice of claim 2, wherein the sweetening compound includes at least one of soybean polysaccharide, trehalose, and Stevia rebaudiana.

12. The cooked rice of claim 1, further comprising a protein compound.

13. A cooked rice amenable for refrigerated or frozen storage comprising:
hydrated rice derived from uncooked rice having at least one of small and medium grains; and
a vinegar solution having:
at least one of a white vinegar and a rice vinegar;
a salt containing at least one of sodium chloride, potassium chloride and potassium lactate;
a non-sucrose, non-fructose containing sweetener; and
an additive having at least one of a bread, at least on meat, at least one vegetable, a hydrocoiloid, an enzyme, and at least one flavoring agent.

14. The cooked rice of claim 13, wherein the meat includes fish.

15. The cooked rice of claim 13, wherein the at least one of sodium chloride, potassium chloride and potassium lactate Is added at a ratio equivalent to approximately 10 to 20 grams for the combined total of sodium chloride, potassium chloride, and potassium lactate per that quantity of hydrated rice derivable from 453 grams of uncooked rice.

16. The cooked rice of claim 13, wherein the non-sucrose, non-fructose containing sweetener includes at least one of soybean polysaccharide, trehalose, and Stevia rebaudiana.

17. A cooked rice amenable for refrigerated or frozen storage comprising:
hydrated rice derived from uncooked rice:
an acidic compound;
a sweetening compound; and
a salt compound including 10-20 grams of a salt per 453 grams of uncooked rice.

18. The cooked rice of claim 17, wherein the sweetening compound includes 0-29 grams of at least one of sucrose and fructose per 453 grams of uncooked rice.
